(19) United States
(12) Patent Application Publication
(10) Pub. No.: US 2013/0304812 A1
(43) Pub. Date: Nov. 14, 2013

(54) CHAIN MANAGEMENT SYSTEM, REMOTE MANAGEMENT METHOD THEREOF AND USER SCREEN DISPLAYING METHOD THEREFOR

(71) Applicants: Sangwon Yun, Seoul (KR); Duckgu Jeon, Seoul (KR)

(72) Inventors: Sangwon Yun, Seoul (KR); Duckgu Jeon, Seoul (KR)

(21) Appl. No.: 13/980,685

(22) PCT Filed: Dec. 27, 2011
(86) PCT No.: PCT/KR2011/010068

§ 371 Date: Jul. 19, 2013

(30) Foreign Application Priority Data
Jan. 21, 2011 (KR) 10-2011-0006537
Jan. 21, 2011 (KR) 10-2011-0006538
Jan. 21, 2011 (KR) 10-2011-0006539

(51) Int. Cl. H04L 29/06

(52) U.S. Cl. CPC H04L 67/42
USPC 709/203

(57) ABSTRACT

A chain management system includes at least one device located within each chain store to transmit status data thereof and receive control data, a central server to generate device management data and the control data based on the status data, a remote management server connected to the central server to provide the device management data and the control data, and a plurality of terminals each to receive a screen on which the status data is displayed according to the control data. With the configuration, a manager of each chain store can remotely manage and control each device within the corresponding chain store in a convenient manner, and effectively detect and notify an error generation from each device, thereby avoiding data overload in a server. Also, each of a plurality of terminals for managing the chain stores can be provided with a differently displayed screen, thereby improving user convenience and reducing a screen generation and loading time of the terminal.

### TECHNICAL FIELD

The present disclosure relates to a chain (store) management system, a remote management thereof and a user screen displaying method therefor.

### BACKGROUND ART

Chain stores correspond to a store organization for centralized control of a plurality of stores selling various kinds of products. A manager who manages the plurality of stores can provide the various kinds of products to a user who runs his store with lower prices than commercial price. Also, a running cost for each store can be reduced by virtue of the manager's full management of the plurality of stores. In addition, the manager or user can execute advertisements for the plurality of products at all.

As various types of devices and facilities within the chain store are modernized, the current trend is an increase in requirements for developing a chain management system for energy management of a power source, lighting, and the like installed in the chain store, and general management of a sub system such as an air conditioner, a refrigerator, a freezer, a showcase and the like.

### DISCLOSURE OF INVENTION

### Technical Problem

Here, in view of generally managing the sub systems installed within the chain, the following problems are considered.

First, when desiring to manage devices and facilities within each chain store by remote control using a terminal, a manager of each chain store should be able to effectively manage and control the devices and facilities. That is, in the related art, since each chain store is remote from a central server which manages those chain stores, there is a problem that the central server is unable to effectively manage those chains.

Second, when other devices including the sub system within each chain are malfunctioned and a manager of the corresponding chain is outside the chain, it is necessary to deal with the malfunction (error) in each chain. However, the related art has the limitation in the aspect that a reference of the occurrence of the malfunction is indiscriminately applied to every chain. In addition, even when the malfunction is detected, a notification for the malfunction occurrence is immediately sent to the manager or a service center, the manager or service center receive many messages, thereby causing an overhead.

Finally, since terminals for managing chains, respectively, receives the same screen from the central server, which manages the chains, it is difficult to construct a screen of each terminal to be dynamically changeable according to user convenience, due to a fixed user interface (i.e., an interface of an owner of a chain). In addition, the terminal receives even unnecessary information at all, which causes inconvenience. When the terminal accesses the central server, there is a problem of taking a long time for loading a screen.

### Solution to Problem

Therefore, to obviate those problems, an aspect of the detailed description is to provide a chain management system, capable of allowing a manager of each chain to easily manage and control devices within the chain by remote control, individually notifying an error generation of a device within the chain to a user or manager of chains, and providing different screens to terminals managing chains, respectively, a remote management method thereof, and a user screen displaying method therefor.

Another aspect of the detailed description is to provide a chain management system, capable of easily managing and controlling devices within a chain located remote from a central server, preventing data overload by allowing a user to set a reference for an error generation for each device within a chain and transmit the set reference to a manager server or service center, and reducing a screen generation and loading time of a terminal, a remote management method thereof, and a user screen displaying method therefor.

To achieve these and other advantages and in accordance with the purpose of the present invention, as embodied and broadly described herein, there is provided a chain management system including at least one device located within a chain store to transmit status data, at least one terminal having a user screen to display device management data for the device, and a central server to generate first data for management and control of the device based on the status data and the device management data and provide the first data to the device, the central server generating second data based on the status data and device management screens searched so as to configure a different user screen and providing the corresponding user screen to the terminal.

In one exemplary embodiment, the system may further include a gateway connected between the terminal and the central server to transmit and receive the first data and the second data.

In one exemplary embodiment, the system may further include a remote management server connected to the central server to provide the device management data for management of the device, and the remote management server may be a web server to generate the device management screen.

In one exemplary embodiment, the central server may transmit screen control data for the device management screen and the first data to the web server and the device, respectively.

In one exemplary embodiment, the central server may generate the first data based on a control command input by the terminal, and generate the device management data or the screen control data based on a search command input by the terminal.

In one exemplary embodiment, the central server may further include a storage unit to store search information on the device management screen and the status data in an accumulative manner.

In one exemplary embodiment, the storage unit may include a first storage portion to receive the status data from the device and store the status data, and a second storage portion to store search information on the device management screen from an access to the central server to a termination of the access.

In one exemplary embodiment, the system may further include a local controller to transmit the first data for remote control of the device from the central server to the device.

In one exemplary embodiment, the gateway may be disposed between the local controller and the central server so as to convert the status data according to a remote communication protocol and transmit the converted data to the central server, the gateway transmitting the first data to the local controller.

In one exemplary embodiment, the central server may further include an application server to generate the first data for remote control of the device according to the remote communication protocol.

In one exemplary embodiment, the application server may generate the first data based on user information input via a window disposed on the device management screen, or by analyzing the status data stored in the storage unit.

In one exemplary embodiment, the status data may be at least one of air conditioner information, refrigeration information, lighting information, power consumption information, device history information, facility error information and a power-consumed information, each detected at a current access time.

In one exemplary embodiment, the device management screen may be at least one of screens for air conditioner information, refrigeration information, power consumption information, facility information, error history information, error setting information and detailed information on energy consumption.

In one exemplary embodiment, the screen control data may include a header containing data of system information and version information relating to the device, and a body containing an ID, a group number, an operational state, an operation mode, temperature and power consumption relating to the device.

In one exemplary embodiment, the system may further include a web server to generate a different user screen for each terminal based on the second data received from the central server.

In one exemplary embodiment, the central server may arrange a user context, to which the device management screen is reflected, on the user screen, and generate the second data to display the status data on a data box of the user context.

In one exemplary embodiment, the user context may be divided windows or lists, and an arrangement order of the divided windows or lists may correspond to a search rate or lately searched order for the device management screens performed by the terminal upon previous accesses thereof, or a size of the divided window may be decided according to the search rate.

In one exemplary embodiment, the central server may include an input unit to receive the status data from the device, a control unit to arrange the device management screens on the user screen, based on the device management screen and the status data input via the input unit, and generate the second data to display the status data on the device management screens, and an output unit to output the second data to the web server.

In one exemplary embodiment, the control unit may include a screen configuring portion to configure the user screen such that the device management screens are arranged on the user screen, and a main controller to display the status data on the user screen and generate the second data for reconfiguring the user screen configured by the screen configuring portion.

In one exemplary embodiment, the first data may be error history data of the device, the central server may include a database to store, in an accumulative manner, the status data, error setting data including preset threshold value and threshold time, and the error history data.

In one exemplary embodiment, the system may include a remote management server connected to the central server to provide device management data for management of the device, and the central server may include a state control unit to detect whether an error is generated in the device from the status data, and output the error history data to the remote management server when the erroneous state is continued over the threshold time.

In one exemplary embodiment, the state control unit may include a variable setting portion to set error setting data, and a signal generating portion to initialize an operation time when the status data value is greater than a threshold value set by the variable setting portion, and generate and output a lapse signal when the operation time exceeds the threshold time.

In one exemplary embodiment, the state control unit may further include a state managing portion to store the error history data generated during the operation time of the signal generating portion in the database in an accumulative manner, and output the error history data to the remote management server when the lapse signal is received from the signal generating portion.

In one exemplary embodiment, the state control unit may further include a state checking portion to receive status data from each device determined to be erroneous and check whether the erroneous state is continued when the lapse signal is received from the signal generating portion.

In one exemplary embodiment, the state control unit may further include a state determining portion to determine presence or non-presence of the error by analyzing the status data.

In one exemplary embodiment, the state control unit may further include a message transmitting portion to convert error history data of a device, checked by the state checking portion as the erroneous state being continued, into a format of email or Short Message Service (SMS) so as to transmit to a user.

To achieve these and other advantages and in accordance with the purpose of the present invention, as embodied and broadly described herein, there is provided a user screen display method for a chain management system, which includes at least one device located within each chain store to transmit status data thereof, at least one terminal having a user screen to display the status data of the device, and a central server connected to the terminal via a network, the method performed by a central server including storing search information relating to a device management screen searched by the terminal, receiving the status data from the device, generating control data for the terminal based on the device management screen and the status data, and displaying a different user screen for each terminal according to the control data.

To achieve these and other advantages and in accordance with the purpose of the present invention, as embodied and broadly described herein, there is provided a remote management method for a chain management system, the chain management system comprising at least one device located within each chain store to transmit status data thereof, at least one terminal having a user screen to display the status data of the device, and a central server connected to the terminal via a network, the method performed by a central server including receiving the status data, generating error history data while an erroneous state that the status data is greater than a preset threshold value is continued, and outputting the error history data to a remote management server or a user when the continued time of the erroneous state exceeds a preset threshold time.

### Advantageous Effects of Invention

As described above, the exemplary embodiments of this specification may provide a chain management system for providing a different screen for each of a plurality of terminals, which manage chain stores, based on device management screens and status data, and a user screen display method thereof. According to the system and method, search information on the device management screens may be stored and a user context may be created from the search information in advance, so as to receive only data related to the user context when the terminal re-accesses a central server, thereby reducing a generation and loading time of a screen of the terminal.

The exemplary embodiments may employ a central server, which generates control data based on status data and transmits device management data and the control data to a remote management server and a device, respectively, thereby allowing a manager of each chain store to manage and control devices within the corresponding chain store by remote control. Also, the provision of the remote management server, which is connected to the central server to provide the device management data for management of the device, may allow for management and control of devices within chain stores located at remote positions from the central server.

In addition, the exemplary embodiments may employ a central server which outputs error history data to a remote management server or report the same to a user or manager, so as to individually notify an occurrence of an erroneous state of devices within each chain store to a user or manager of the corresponding chain store, thereby efficiently managing the chain store. To this end, the central server may compare status data with a preset threshold value to generate and update error history data when the erroneous state is continued and output the error history data when a preset threshold time elapses, thereby preventing data overload toward a manager server or service center.

### BRIEF DESCRIPTION OF DRAWINGS

FIG. 1 is a block diagram of a chain management system in accordance with one exemplary embodiment;

FIG. 2 is an exemplary block diagram showing detailed components of a central server and a web server of FIG. 1;

FIG. 3 is an exemplary block diagram showing detailed components of the central server and the web server of FIG. 1;

FIG. 4 is an exemplary block diagram showing detailed components of a state control unit of FIG. 3;

FIG. 5 is an exemplary block diagram showing detailed components of the central server and the web server of FIG. 1;

FIGS. 6A to 6G are exemplary views of device management screens in accordance with one exemplary embodiment;

FIG. 7 is a view showing an error reference setting screen for setting a reference for an error determination for each device in the chain management system;

FIG. 8 is a view showing an alarm reception setting screen for setting details related to the alarm reception in the chain management system;

FIG. 9 is a view showing a screen of a terminal in accordance with one exemplary embodiment;

FIG. 10 is a view showing a screen of a terminal in accordance with another exemplary embodiment;

FIGS. 11 to 16 are flowcharts each showing a remote management method for a chain management system in accordance with exemplary embodiments; and

FIGS. 17 and 18 are flowcharts each showing a method for displaying a screen of a terminal in a chain management system in accordance with exemplary embodiments.

### MODE FOR THE INVENTION

Embodiments of the present invention will be described below in detail with reference to the accompanying drawings where those components are rendered the same reference number that are the same or are in correspondence, regardless of the figure number, and redundant explanations are omitted. In describing the present invention, if a detailed explanation for a related known function or construction is considered to unnecessarily divert the gist of the present invention, such explanation has been omitted but would be understood by those skilled in the art. The accompanying drawings are used to help easily understood the technical idea of the present invention and it should be understood that the idea of the present invention is not limited by the accompanying drawings. The idea of the present invention should be construed to extend to any alterations, equivalents and substitutes besides the accompanying drawings.

Hereinafter, description will be given in detail of a chain management system, a remote management method thereof and a user screen displaying method therefor, with reference to the accompanying drawings.

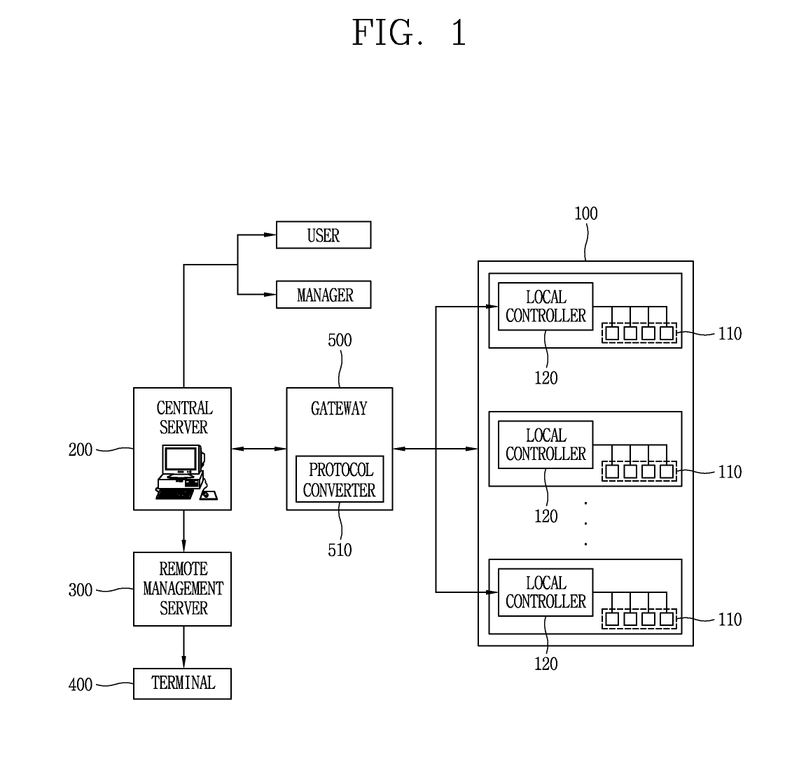

FIG. 1 is a block diagram of a chain management system in accordance with one exemplary embodiment. A chain management system, as shown in FIG. 1, may include a chain store system 100 having a plurality of chain stores each having at least one device 110, a central server 200 connected to the chain store system 100 via a network, and a remote management server (web server) 300 connected to the central server 200 to provide device management data to manage the device 110.

The chain store system 100 may include a local controller 120 to receive status data from each device 110. The local controller 120 may transmit operation control data for remote control of the device 110 from the central server 200 to each device 110.

The chain store system 100 may include at least one device 110 disposed within each chain store to transmit status data. Here, the at least one device 110 may include an air conditioner, a refrigerator, a freezer, a showcase and the like. Also, the status data may correspond to a current temperature of the device 110. For example, the status data corresponds to a room temperature for the air conditioner, and an interior temperature for the refrigerator, the freezer and the showcase. The status data may also include moisture and a flow rate in addition to the current temperature. In addition, the device 110 may include facilities, such as a watt-hour meter, within the corresponding chain store, so the status data may include power consumption (an amount of consumed power) of each device and entire power consumption within the chain store. In other words, the status data may include at least one of air conditioner information, refrigeration information, lighting information, power consumption information, device history information, installation and error information and a power-consumed amount.

The remote management server 300 may be a web server to generate a device management screen for managing the at least one device 110 within the chain store. The chain management system may further include a plurality of terminals 400 each connected to the remote management server 300 via a network so as to receive the device management screen from the remote management server 300 and display the screen.

Here, the device management screen may be one of screens respectively relating to air conditioner information, refrigeration information, power consumption information, facility information, error history information, error setting information and detailed information on energy consumption.

The plurality of terminals 400 may be located either inside or outside the chain stores. The plurality of terminals 400 may display a device management screen or a web page screen, which is generated by receiving the device management data or screen control data from the remote management server (or web server) 300.

The chain management system may further include a gateway 500 located between the local controller 120 and the central server 200 so as to convert the status data according to a remote communication protocol to transmit to the central server 200.

The gateway 500 may correspond to a router to transmit and receive a signal corresponding to the status data. The gateway 500 may include a protocol converter 510 to convert the status data according to the remote communication protocol.

The central server 200 may generate first data to manage and control the device 110 based on the status data and the device management data, and may provide the first data to the device 110. The central server 200 may also generate second data to configure a different user screen for the terminal 400 based on the status data and a searched device management screen, and provide the second data to the terminal 400. p Referring to FIG. 1, the central server 200 may generate the device management data and the operation control data (first data) based on the status data, and transmits those data to the remote management server 300 and the device 110, respectively.

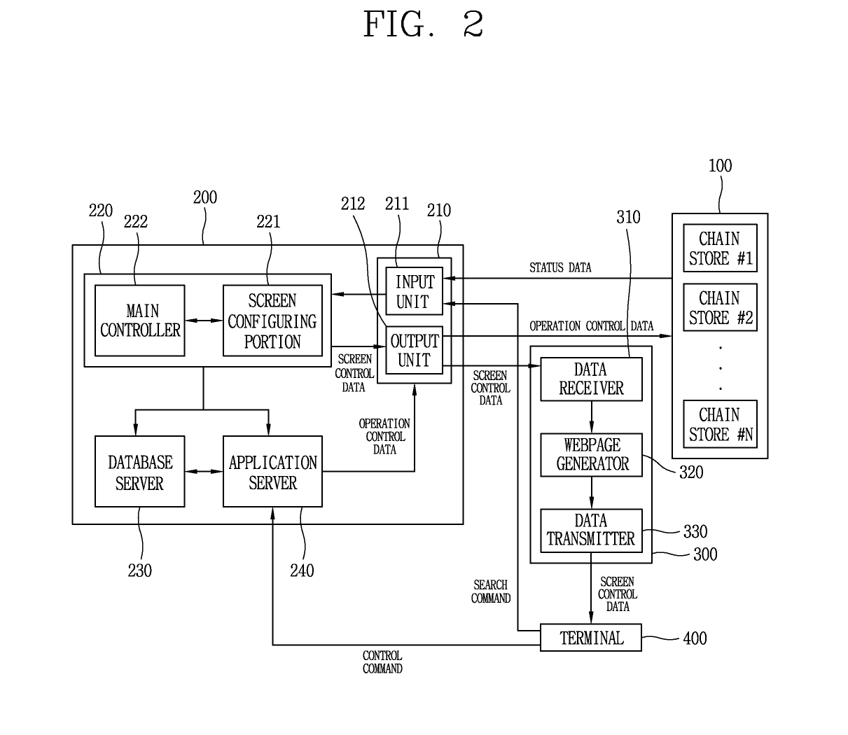

As shown in FIGS. 1 and 2, the central server 200 may generate screen control data for a device management screen and the operation control data (first data) based on the statue data, and transmit the screen control data and the operation control data (first data) to the web server (or remote management server) 300 and the device 110, respectively.

The central server 200 may generate the operation control data (first data) based on a control command input via the terminal 400 (see FIG. 1), and generate the device management data or the screen control data based on a search command input via the terminal 400.

The central server 200 may be connected to the device 110, and generate error history data (first data) when an erroneous (abnormal, malfunctioned) state that the status data is greater than a preset threshold value is continued.

The central server 200 may output the error history data (first data) to the remote management server (or web server) 300 or to a user or manager when the continued time of the erroneous state exceeds a preset threshold time. Accordingly, the chain store can be effectively managed by notifying an occurrence of the erroneous state of the device within each chain store to the user or manager of the chain store, and also data overload toward a manager server or service center can be avoided.

The central server 200 may generate control data (second data) for the plurality of terminals 400 based on the device management screens searched by the plurality of terminals 400 and the status data, and allow the plurality of terminals 400 to display different user screens according to the control data (second data).

In detail, the central server 200 may position a user context, to which the device management screen is reflected, on the user screen, and generate the control data (second data) for displaying the status data on a data box of the user context. Here, the context is information affecting to an interaction between a user and a service, namely, is defined as information affecting to an execution of a web service and the executed result. Here, the context may include a user context for reflecting a different situation for each user, and a system context which is preset by a developer according to necessity for an operation of a management system.

The user context may be divided windows or lists. An arrangement sequence of the divided windows or lists may be decided in correspondence with a search rate or a lately searched order of the device management screens upon previous access of the terminal.

FIG. 2 is an exemplary block diagram showing detailed components of the central server and the remote management server of FIG. 1.

As shown in FIG. 2, the central server 200 may include an interface unit 210, a control unit 220 and a database server 230. The central server 200 may further include an application server 240.

The interface unit 210 may allow for transmission or reception of the status data and control data (second data) between the at least one device 110 or terminal 400 and the central server 200. The interface unit 210 may include an input unit 211 to receive the status data from the device 110 and transfer the status data to the control unit 220, and an output unit 212 to receive the screen control data and the operation control data (first data) from the application server 240 and output those data to the web server 350.

The control unit 220 may generate screen control data for displaying the device management screen on the terminal 400 based on the status data and a search command input from the at least one device 110 and the terminal 400 via the input unit 211, and transmit the screen control data to the web server (or remote management server) 300.

Here, the screen control data may include a header, which contains data such as system information and version information related to the device 110, and a body, which contains an ID, a group number, an operational state, an operation mode, temperature, power consumption and the like all related to the device 110.

The control unit 220 may include a screen configuring portion 221 and a main controller 222. The screen configuring portion 221 may generate screen configuration control data to arrange the device management screen on each terminal 400. Also, the main controller 222 may generate the screen control data based on the screen configuration control data to display the status data on the device management screen.

The database server 230 may store the status data received from the device 110 in an accumulative manner.

The application server 240 may generate the operation control data for remote control of the device 110 according to a remote communication protocol.

In detail, the application server 240 may generate operation control data (first data) from user information input via a window arranged on the device management screen.

The application server 240 may generate operation control data (first data) by analyzing the status data stored in the database server 230.

The web server (or remote management server) 300 may include a data receiver 310 to receive the screen control data and the operation control data (first data) from the central server 200, a web page generator 320 to generate a web page corresponding to a device management screen to be provided to the terminal 400 based on the screen control data, and a data transmitter 330 to transmit the web page generated from the web page generator 320 to the corresponding terminal 400.

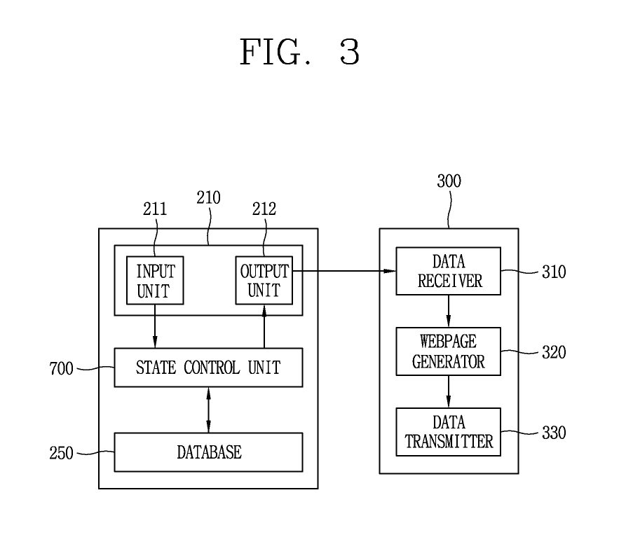

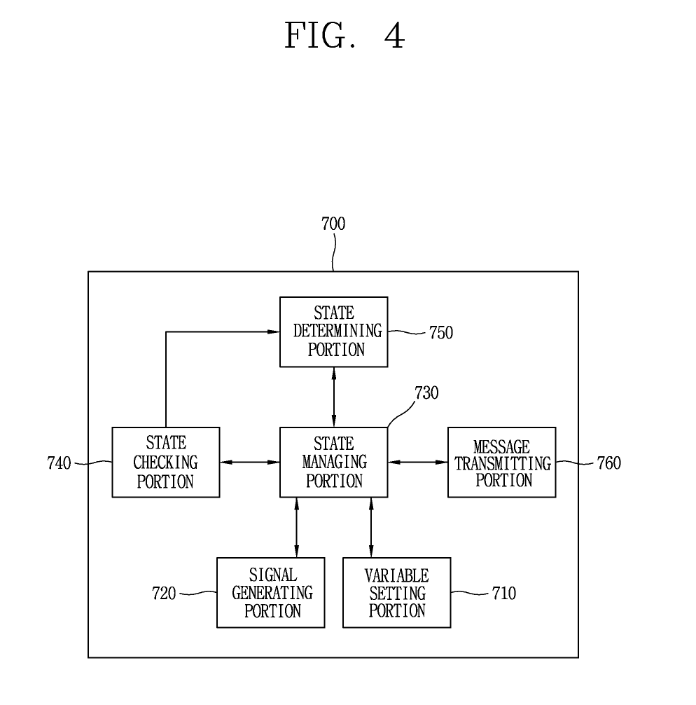

FIG. 3 is another exemplary block diagram showing detailed components of the central server and the remote management server of FIG. 1, and FIG. 4 is a block diagram showing detailed components of the state control unit of FIG. 3.

As shown in FIG. 3, the central server 200 may include an interface unit 210 and a database 250. The central server 200 may further include a state control unit 700.

The interface unit 210 may be located between the device 110 or the remote management server 300 and the central server 200, to receive and transmit the status data and error history data (first data), respectively. The interface unit 210 may include an input unit 211 to receive status data from each device 110 and transmit the status data to the state control unit 700, and an output unit 212 to receive error history data from the state control unit 700 to output to the remote management server 300.

The database 250 may store, in an accumulative manner, the status data, error setting data containing the threshold value and the threshold time, and the error history data (first data). The database 250 may also store a program or data associated with the central server 200. For example, the error setting data may include a threshold value indicating an upper limit of temperature determined as a error when the status data is ‘temperature value,’ and a threshold time indicating a time for which a value greater than the threshold value is continued.

The web server (or remote management server) 300 may include a data receiver 310 to receive the screen control data from the central server 200, a web page generator 320 to generate a web page corresponding to the device management screen on the terminal 400 based on the screen control data, and a data transmitter 330 to transmit the web page generated from the web page generator 320 to the terminal 400.

Referring to FIGS. 3 and 4, the state control unit 700 may detect whether or not the device 110 is in an erroneous state based on the status data through the program, and output the error history data (first data) to the web server (or remote management server) 300 when the erroneous state is continued over the threshold time.

The state control unit 700 may include a variable setting portion 710, a signal generating portion 720 and a state managing portion 730. The state control unit 700 may further include a state checking portion 740, a state determining portion 750 and a message transmitting portion 760.

The variable setting portion 710 may set the error setting data as a variable necessary to determine the erroneous state of the device 110. The error setting data may initially be set upon installation of the chain management system 110 or change into a value input via the terminal 400.

The signal generating portion 720 may be initialized operating time when the status data value is greater than the threshold value set in the variable setting unit 710. The signal generating portion 720 may generate and output a lapse signal when the operating time exceeds the threshold time. For example, the signal generating portion 720 may be a timer whose operating time is initialized when the current temperature of the device 110 is higher than a preset temperature upper limit value and which generates a lapse signal when the operating time exceeds the threshold time.

The state managing portion 730 may accumulate and store the error history data (first data) generated for the operating time of the signal generating portion 720 in the database 250. The state managing portion 730 may output the error history data to the web server 300 when the lapse signal is received from the signal generating portion 720.

The state checking portion 740 may receive the status data of each device 110, which is determined to be in the erroneous state, so as to check whether the erroneous state is continued when the lapse signal is received from the signal generating portion 720.

The state determining portion 750 may determine presence or non-presence of the error by analysis of the status data.

The message transmitting portion 760 may convert the error history data of the device 110, which has been determined as the erroneous state being continued by the state checking portion 740, into an email or Short Messaging Service (SMS) format, thereby transmitting the converted error history data to the user or manager.

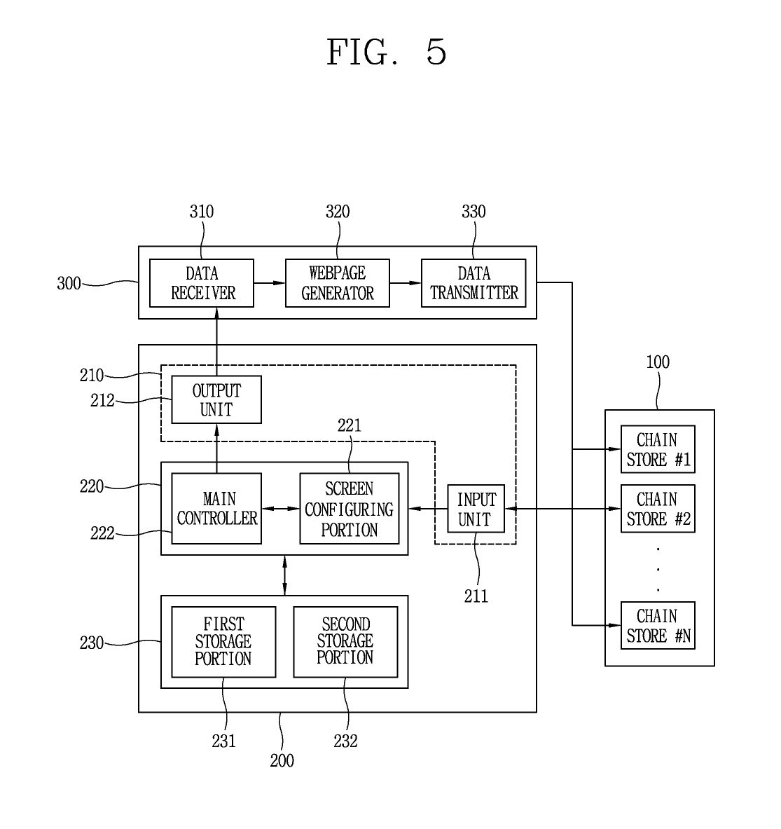

FIG. 5 is an exemplary block diagram showing detailed description of the central server and the remote management server of FIG. 1.

The central server 200 may include the interface unit 210 and the control unit 220. The central server 200 may further include a database unit 230.

The interface unit 210 may allow for transmission or reception of the status data or the control data (second data) between the at least one device 110 or the plurality of terminals 400 and the control unit 220.

The interface unit 210 may include an input unit 211 to receive the status data input from the at least one device 110, and an output unit 212 to receive the control data from the control unit 220 to output to the web server 300.

The control unit 220 may arrange the device management screen on the user screen based on the device management screen and the status data input via the input unit 211, and display the status data on the device management screen.

The control unit 220 may include a screen configuring portion 221 and a main controller 222. The screen configuring portion 221 may configure the user screen to arrange the device management screen thereon. The main controller 222 may display the status data on the user screen, and generate the control data (second data) to reconfigure the device management screen and the user screen formed by the screen configuring portion 221.

The web server (or remote management server) 300 may include a data receiver 310 to receive the control data from the central server 200, a web page generator 320 to generate web pages corresponding to different user screens for the plurality of terminals 400 based on the control data, and a data transmitter 330 to transmit the web pages generated from the web page generator 320 to the plurality of terminals 400.

The web page generator 320 may arrange a user context from the control data on the user screen on which a system context is arranged, and display the status data on the user context to generate a web page. The user screen on which the system context is arranged is provided in the web server 300 in form of a template, thereby reducing a generation time of the web page. When the terminal 400 re-accesses the central server 200, the control data previously stored in the central server 200 can be transmitted to the web server 300, thereby fast generating a web page.

The chain management system may further include a gateway 500 connected between the plurality of terminals 400 and the central server 200 to transmit and receive the status data and the control data. The gateway 500 corresponds to a router to transmit and receive signals corresponding to the status data and the control data. The gateway 500 may perform a function of a proxy server for improving a user screen loading speed. As such, the proxy server disposed between the terminal 400 and the web server 300 may reduce a data amount transmitted via the terminal 400 using a text file compression or an image file compression.

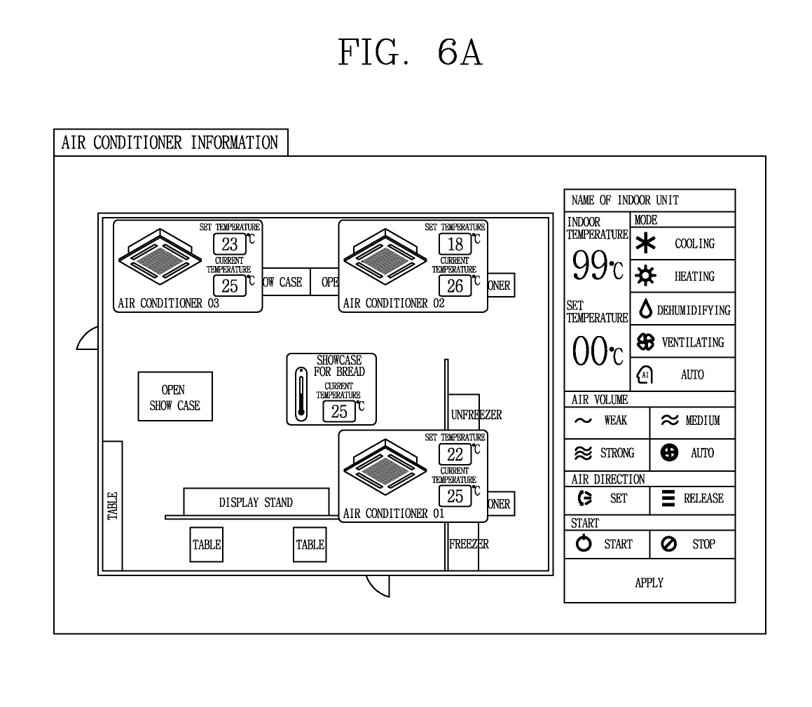

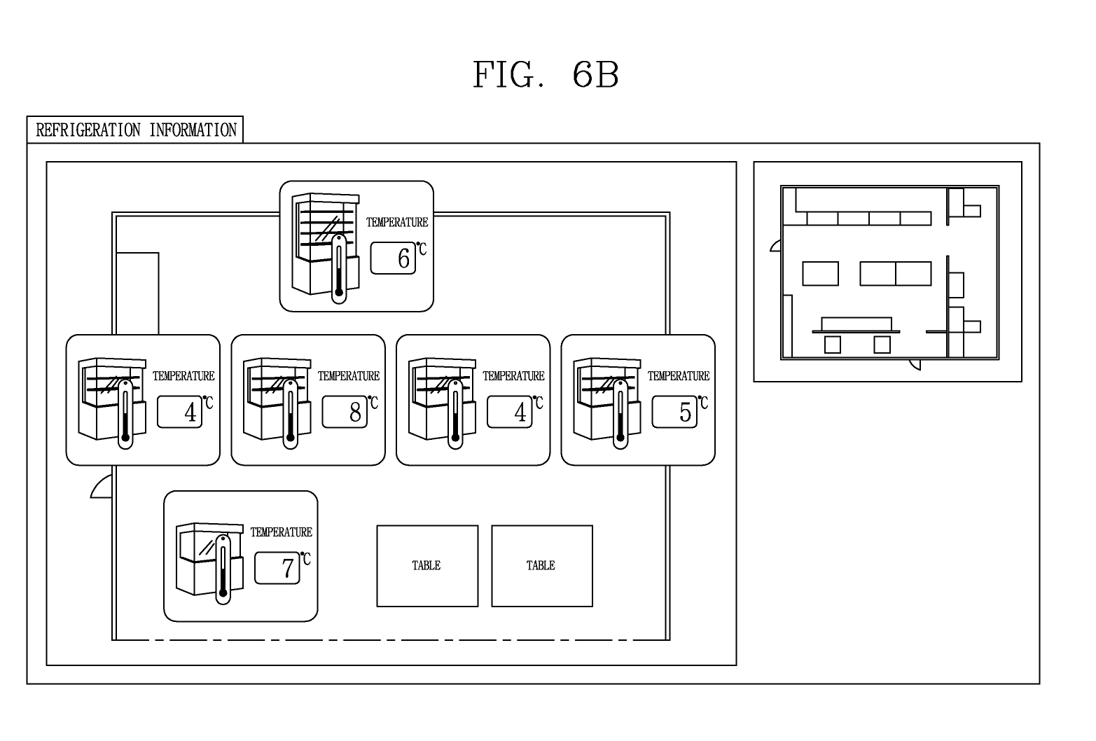

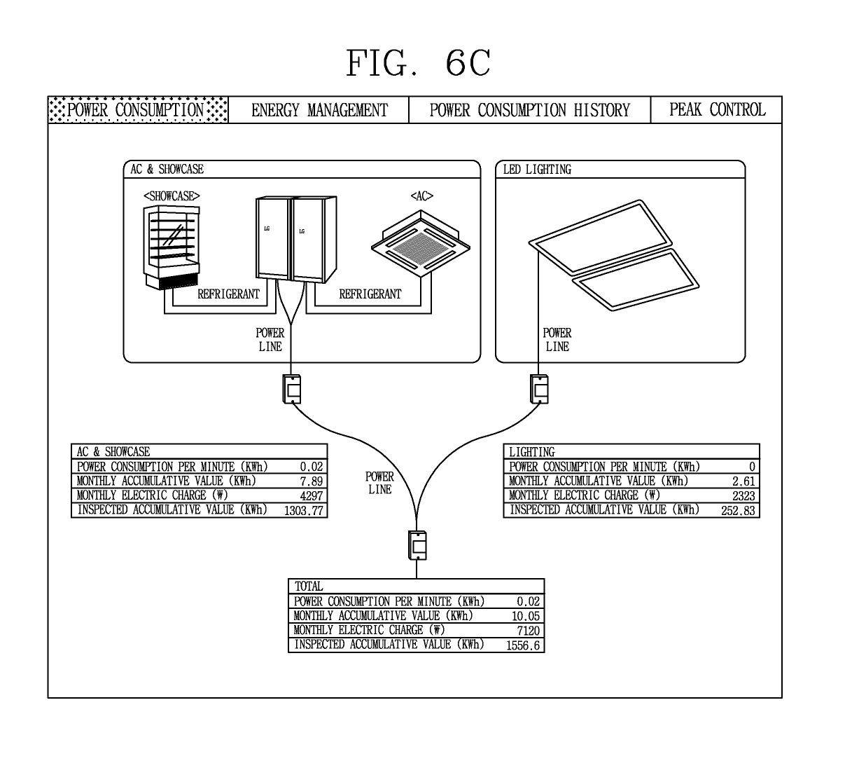

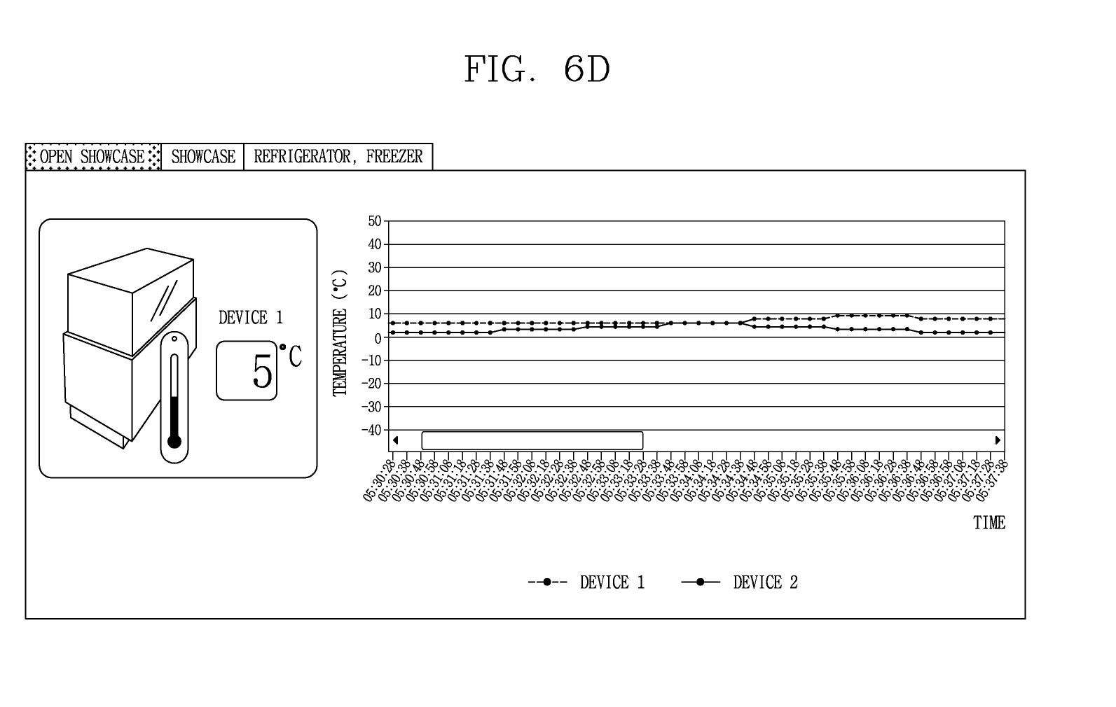

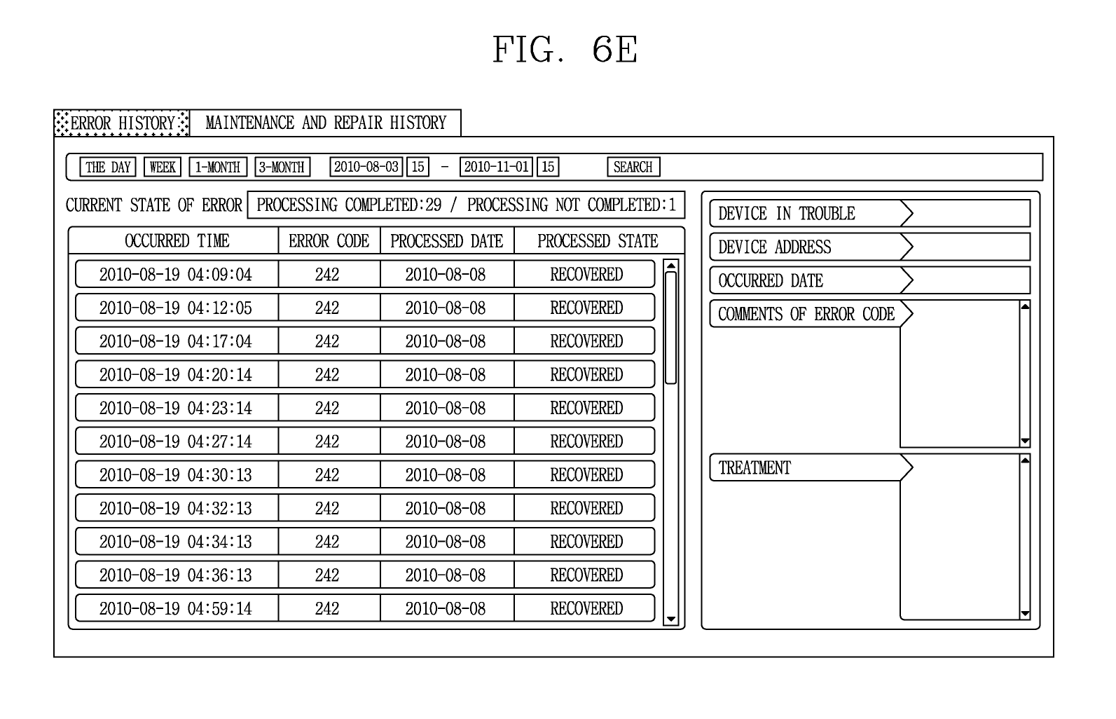

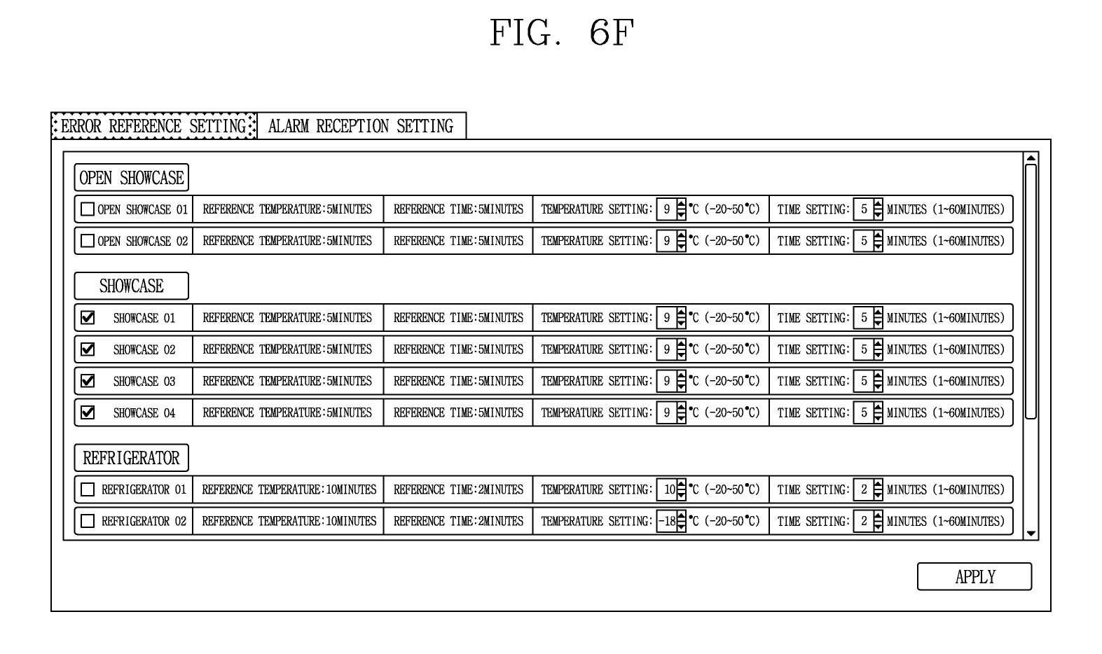

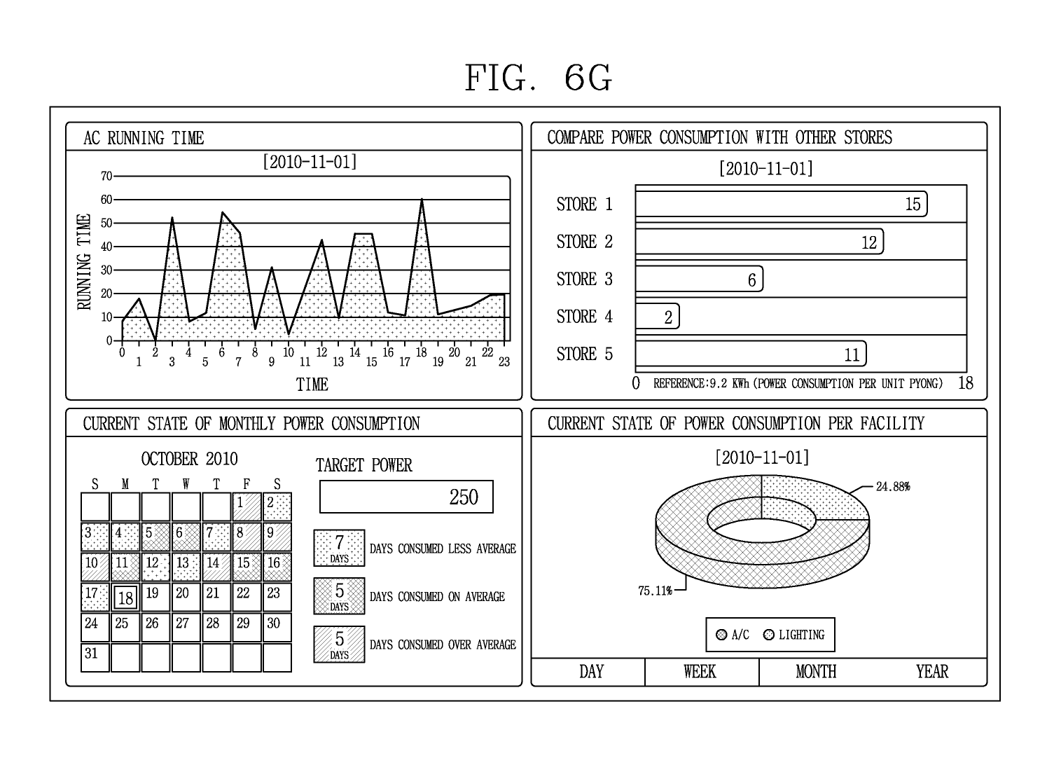

FIGS. 6A to 6G show the exemplary device management screens of FIG. 1. In detail, FIGS. 6A to 6D show device management screens for managing air conditioner information, refrigeration information, power consumption information and device history information, respectively. The device management screens for the air conditioner information and the refrigeration information, as shown in FIGS. 6A and 6B, may display the air conditioner, the refrigerator, the showcase and the like by reflecting positions thereof within the chain store, and also display a current temperature and a set temperature. The device management screen for the power consumption information, as shown in FIG. 6C, may display the power consumption by the device 110 and electric charges of the device 110, and separately display an entire power consumption and the like. The device management screen for the device history information, as shown in FIG. 6D, displays in form of graph a time-based temperature change with respect to at least one of a plurality of air conditioners, refrigerators and showcases installed within the chain store, and separately display the current temperature.

FIGS. 6E and 6F show device management screens for error history information and error indication, respectively. For example, as shown in FIG. 6E, upon clicking a tap located at an upper end of the device management screen, an error history page or a maintenance and repair history page may be displayed on the device management screen. For example, as shown in FIG. 6F, upon clicking the tap located at the upper end of the device management screen, an error reference setting page and an alarm reception setting page may be displayed on the device management screen.

FIG. 6G shows a device management screen for detailed information related to energy consumption. For example, the device management screen may display an air conditioner running time, a comparison of power consumption with other branches, a current state of monthly power consumption, and a current state of power consumption for each facility.

The chain store system 100 may include at least one device 110 which is installed within each chain store so as to transmit and receive status data and operation data to and from the central server 200, respectively. The chain store system 100 may further include a local controller 120 to receive the status data from the at least one device 110, and transmit operation data (first data) for remote control of the device 110 from the central server 200 to the corresponding device 110. Here, the at least one device 110 may include an air conditioner, a refrigerator, a showcase, power equipment, facilities and the like, and the status data may include each temperature of the air conditioner, the refrigerator and showcase at the current access time, an entire power consumption and the like.

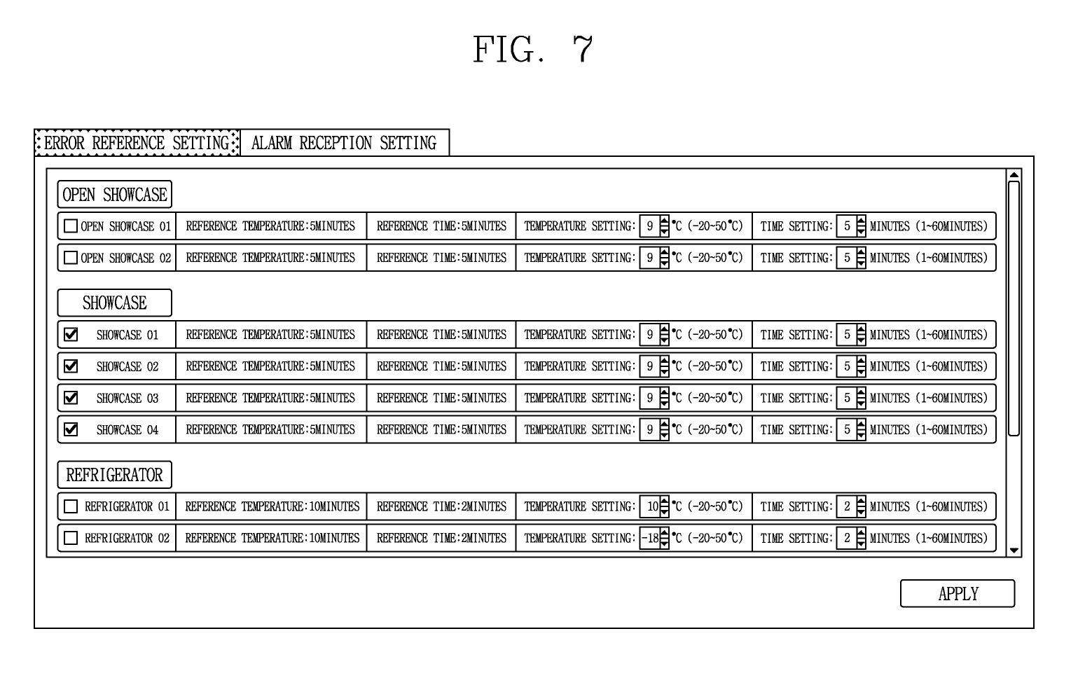

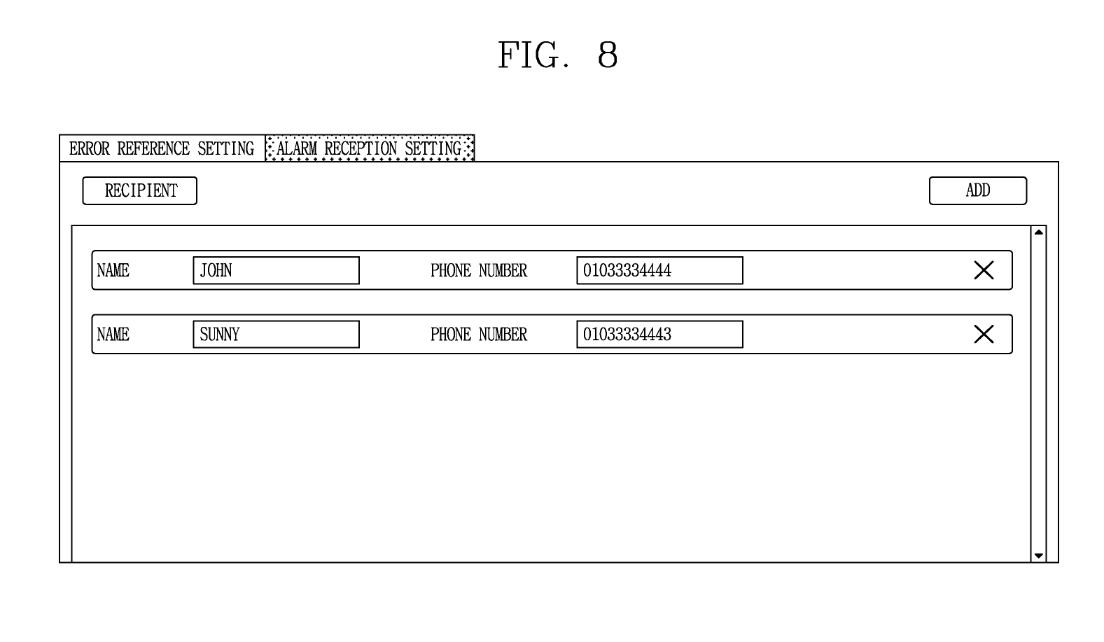

FIGS. 7 and 8 show device management screens displayed on the terminal 400 by control commands performed by the variable setting portion 710 and the message transmitting portion 760. FIG. 7 shows an error reference setting screen for setting a reference for determining occurrence or non-occurrence of an error for each device in the chain management system according to this specification, and FIG. 8 shows an alarm reception setting screen for setting items related to an alarm reception.

As shown in FIG. 7, the error reference setting screen may display a reference temperature and a reference time for a showcase (including an open type), a refrigerator and the like.

Also, as shown in FIG. 8, the alarm reception setting screen may display a name and a contact number of a recipient.

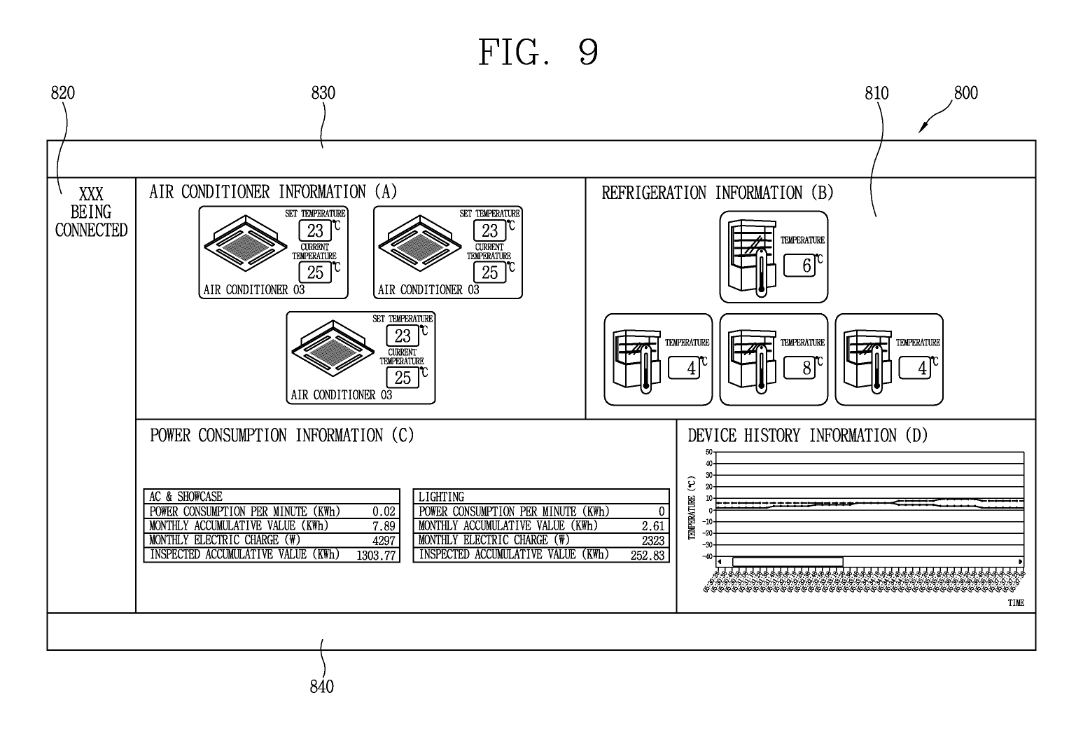

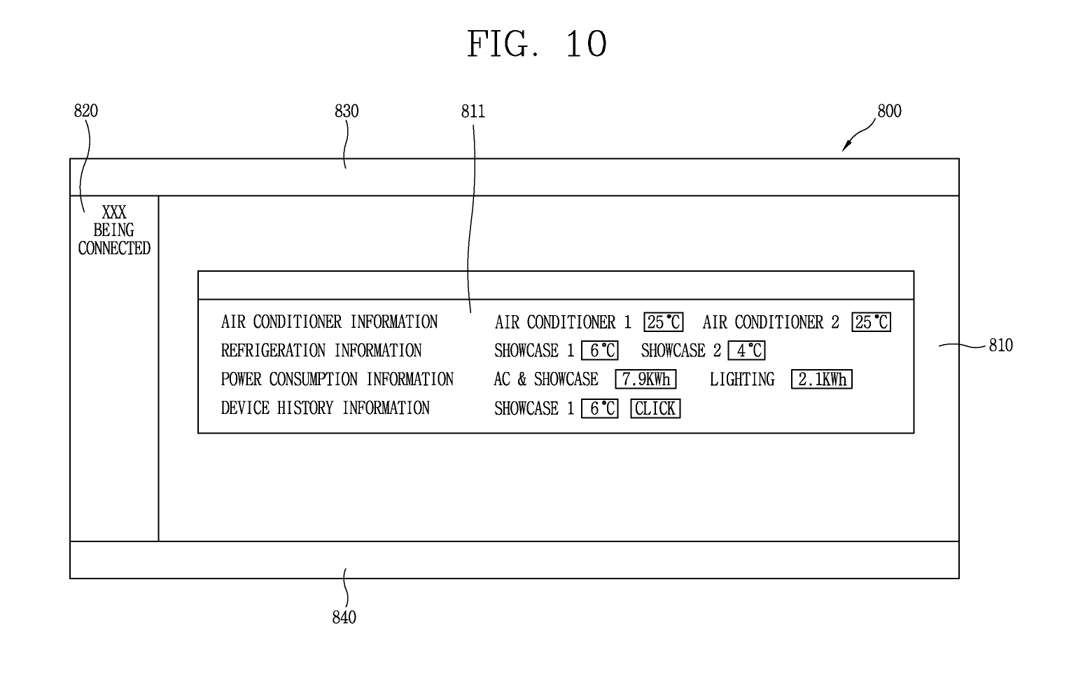

FIG. 9 shows a screen of the terminal in accordance with one exemplary embodiment, and FIG. 10 shows a screen of the terminal in accordance with another exemplary embodiment.

A user context in FIG. 9 corresponds to a divided window, and a user context in FIG. 10 corresponds to a list.

Referring to a user screen of FIG. 9, it can be seen that a search rate or a lately searched order upon previous accesses of the terminal 400 is in the order of the device management screens for the air conditioner information, the refrigeration information, the power consumption information, the device history information. The device management screens disposed on the divided windows may be selectable from the screens for the air conditioner information, the refrigeration information, lighting information, power consumption information, device history information, facility error information and power-consumed information. The device management screen may be selected different for each of the plurality of terminals 400, and not be limited to the listed items. The user screen may be composed of a user context and a system context. The user context may be displayed on a first body 810, and the system context is displayed on a second body 820, a header 830 and a tail 840. Here, the first body 810 may include first to fourth windows A to D.

The control data may be displayed by dividing the user screen into the first to fourth windows A to D, and the device management screens and the user screen may be reconfigured such that the device management screens can be disposed on the first to fourth windows A to D in form of user context. The screen configuring portion 221 (see FIG. 5) may generate coordinates of the first to fourth windows A to D as control data for decision of sizes of the first to fourth windows A to D. The main controller 222 (see FIG. 5) may generate control data by adding, to the control data, object information disposed on the device management screen, coordinates information related to the object and status data of a device corresponding to the object.

Referring to FIG. 10, the user screen may include a user context disposed within the first body 810, and system contexts disposed on the second body 820, the header 830 and the tail 840. The user context may be implemented in form of a list 811 within the first body 810. For generation of the list 811, the screen configuring portion 221 may generate coordinates of the list 811 as control data. The main controller 222 may generate control data by adding, to the control data, object information disposed on the device management screen, and state data of the device corresponding to the object. Items associated with the object contained within the list 811, namely, air conditioner information, refrigeration information, lighting information, power consumption information, device history information, facility error information and a power-consumed amount, may be selected differently for each of the plurality of terminals 400, and the object may not be limited to the listed items.

The database unit 230 may store search information on the device management screen and the status data. The database unit 230 may include a first storage portion 231 to store the status data transmitted from the control unit 220, and a second storage portion 232 to store search information on the device management screen from an initial access to an access termination. The web server 300 (see FIG. 5) may generate different user screens for the plurality of terminals 400, respectively, based on the control data received from the central server 200.

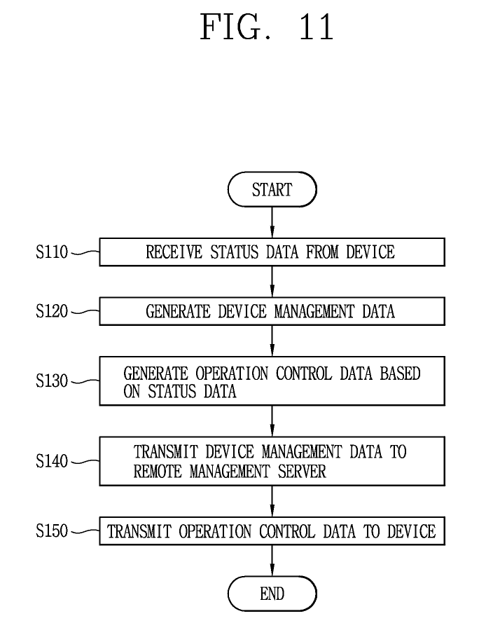

Hereinafter, referring to FIGS. 11 to 16, description will be given of flowcharts of remote management methods for a chain management system in accordance with an exemplary embodiment.

A remote management method for a chain management system in accordance with an exemplary embodiment, in the chain management system including at least one device located within each chain store to transmit status data, at least one terminal having a user screen to display the status data of the device, and a central server connected to the at least one terminal via a network, may include storing search information on a device management screen searched by the terminal, receiving the status data from the device, generating control data for the terminal based on the device management screen and the status data, and differently displaying each user screen of the terminal according to the control data.

Referring to FIG. 11, a remote management method for a chain management system, which includes at least one device located within each chain store to transmit status data thereof, a remote management server to provide device management data for management of the device, and a central server located between the device and the remote management server, may be performed by the central server. As shown in FIG. 11, the remote management method for the chain management system may include first to fifth steps S110 to S150.

The central server may receive the status data from the device in the first step S110. The central server may generate the device management data in the second step S120, and generate operation control data based on the status data in the third step S130. Also, the central server may transmit the device management data to the remote management server in the fourth step S140, and transmit the operation control data to the device in the fifth step S150.

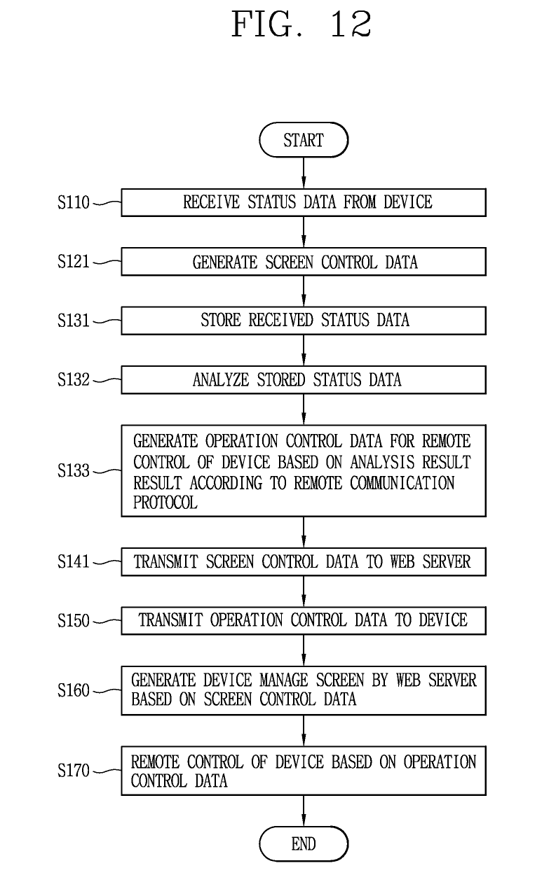

In the remote management method for the chain management system in FIG. 12, the remote management server indicates a web server to generate a device management screen for management of the device. The central server may generate screen control data in a second step S121. A third step S130 may include first to third processes S131 to S133. The first process S131 may be performed to store the control data received, and the second process S132 may be performed to analyze the stored status data, and the third process S133 may be performed to generate operation control data for remote control of the device according to a remote communication protocol. The remote management method for the chain management system may further include sixth and seventh steps S160 and S170. The sixth step S160 may be performed by the web server to generate the device management screen according to the screen control data. The seventh step S170 may be performed by the central server to remotely control the device according to the operation control data.

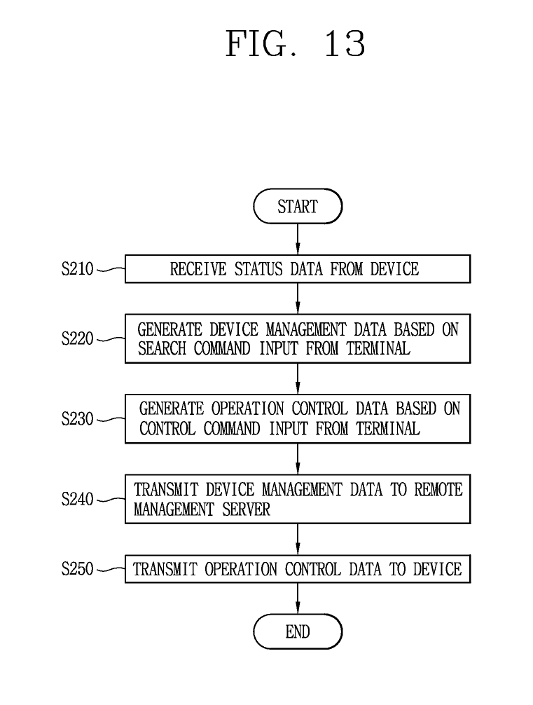

The remote management method for the chain management system of FIG. 13, further including a terminal to receive the device management screen from the remote management server, may be performed by the central server. As shown in FIG. 13, second and third steps S220 and S230 of the remote management method may be described as follows. The central server may generate the device management data based on a search command input from the terminal in the second step S220, and generate the operation control data based on a control command input from the terminal in the third step S230.

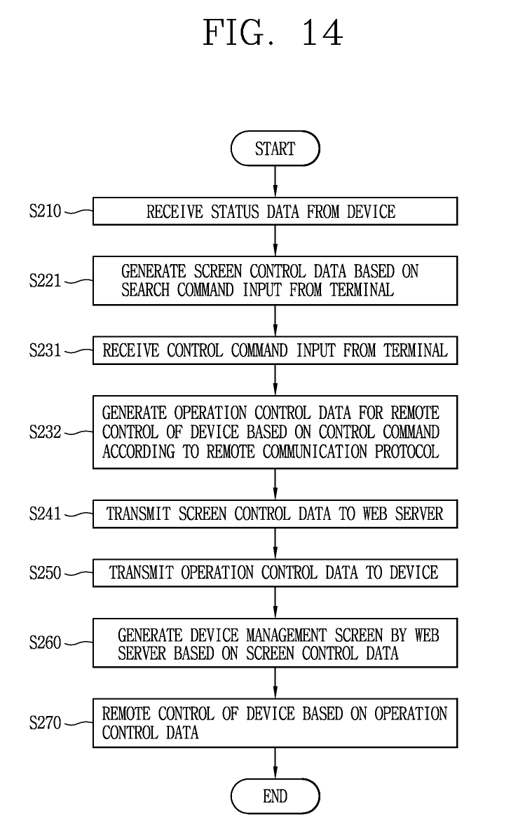

The remote management method for the remote management system of FIG. 14, the remote management server is a web server to generate a device management screen for management of the device. The central server may generate screen control data based on a search command input from the terminal in a step S221. A third step may include first and second processes S231 and S232. The first process S231 may be performed to receive the control command input from the terminal, and the second process S232 may be performed to generate the operation control data for remote control of the device according to the remote communication protocol.

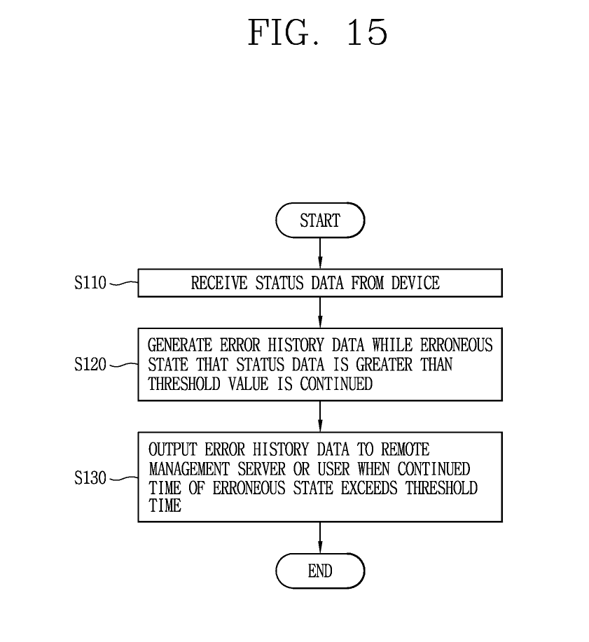

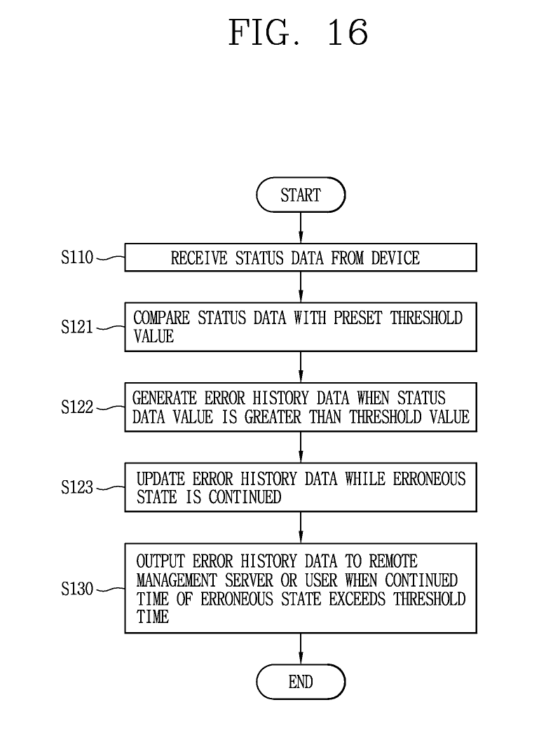

FIG. 15 is a flowchart showing a remote management method for a chain management system according to this specification, and FIG. 16 is a flowchart showing the remote management method for the chain management system of FIG. 6 in detail.

As shown in FIG. 15, the remote management method for the chain management system, which includes at least one device, and a remote management server to provide device management data for management of the device, may be performed by the central server, and include first to third steps S110 to S130.

The central server may receive the status data from the device in the step S110, and update error history data while an erroneous state in which the status data is greater than a preset threshold value is continued in the second step S120. The central server may then output the error history data to the remote management server or a user when the continued time of the erroneous state exceeds a threshold time in the third step S130.

In the remote management method for the chain management system according to the FIG. 16, the second step S120 may include first to third processes S121 to S123. The first process S121 may be performed to compare the status data with a preset threshold value, and the second process S122 may be performed to generate the error history data when the status data value is greater than the threshold value. The third process S123 may be performed to update the error history data while the erroneous state is continued.

A method for displaying a screen of a terminal in a chain management system in accordance with one exemplary embodiment, in the chain management system including at least one device located within each chain store to transmit status data thereof, at least one terminal having a user screen to display the status data of the device, and a central server connected to the terminal via a network, may include receiving the status data, generating error history data while an erroneous state in which the status data is greater than a preset threshold value is continued, and outputting the error history data to a remote management server or a user when the continued time of the erroneous state exceeds a preset threshold time.

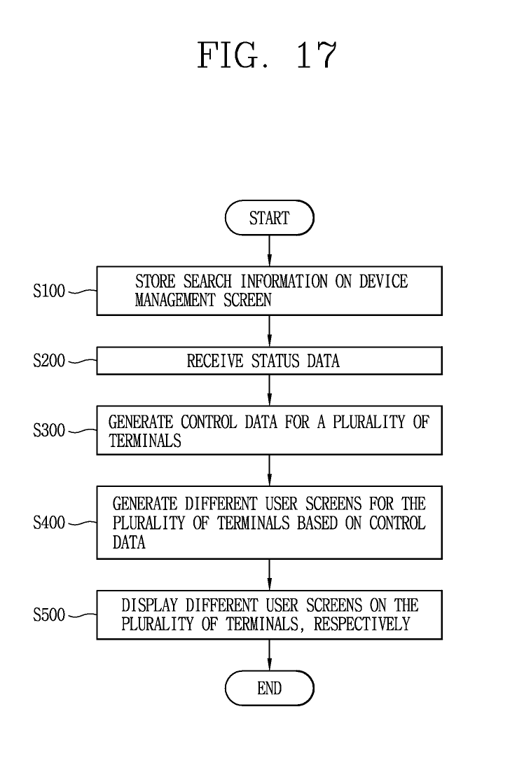

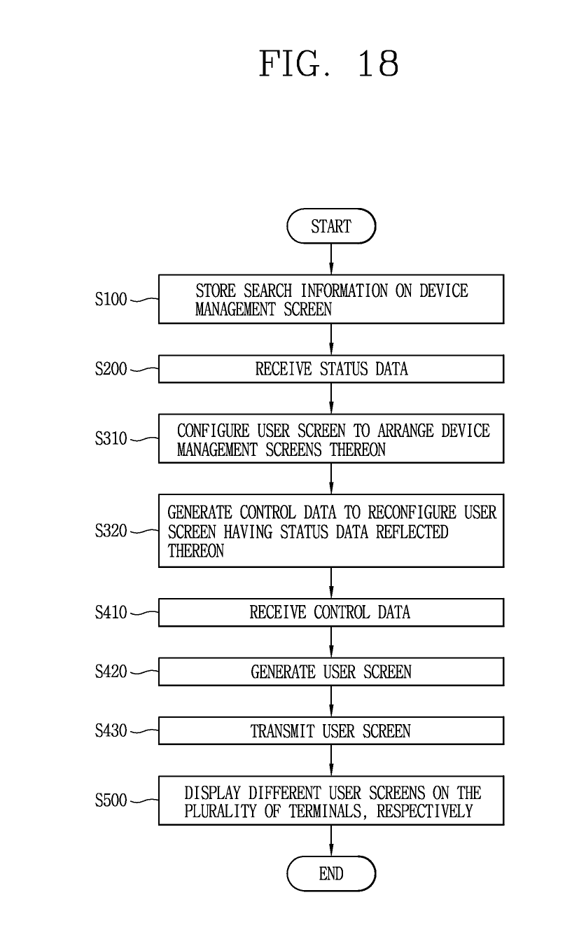

Hereinafter, description will be given of the method for displaying the screen of the terminal in the chain management system with reference to FIGS. 17 and 18.

FIG. 17 is a flowchart showing the user screen generation method according to FIGS. 4 and 5, and FIG. 18 is a flowchart showing the detailed user screen generation method according to FIG. 6.

The user screen generation method for the chain management system according to the one exemplary embodiment, including at least one device located within each chain store to transmit status data thereof, a plurality of terminals to display the status data on a screen, and a central server connected to the plurality of terminals via a network, may be performed by the central server. As shown in FIG. 17, the user screen generation method for the chain management system may include a search information storage step S100, a status data reception step S200, a control data generation step S300, and a user screen display step S500. The user screen generation method for the chain management system may further include a user screen generation step S400.

The central server may store search information related to device management screens searched by the plurality of terminals in the search information storage step S100. The central server may receive the status data from the at least one device in the status data reception step S200. The central server may generate control data for the plurality of terminals based on the device management screens and the status data in the control data generation step S300. Here, the control data may include coordinates of lists disposed within windows into which a user screen is divided or the user screen, or information related to an object disposed on the window or list and position coordinates of the object. The central server may generate different user screens for the plurality of terminals, respectively, based on the control data in the user screen generation step S400. The user screen generation step S400 may include a control data reception process S410, a user screen generation process S420, and a user screen transmission process S430.

A data receiver may receive the control data generated in the control data generation step S300 in the control data reception process S410, so as to generate different user screens for the plurality of terminals, respectively, based on the control data, thereby reducing a time taken by loading the user screen.

The user screen generation process S420 may be performed to generate the different user screens for the plurality of terminals, respectively, based on the received control data. The user screen may be a web page.

The user screen transmission process S430 may be performed to transmit the generated user screens to the plurality of terminals, respectively. The user screen transmitted to each of the plurality of terminals may be a web page, for example, and the transmitted data may be HTML data as web data. In the user screen display step S500, the plurality of terminals may display the different user screens generated according to the control data. With respect to the web page as one example of the user screen, a web browser installed in the terminal may display a web page on the terminal according to the following method. The HTML data as the web data is parsed, a Java script is parsed for execution, and then Cascading Style Sheets (CSS) data is parsed so as to generate a web page. The web page is then arranged and rendered on the user screen of the terminal, and contents are downloaded so as to configure a webpage screen for which the terminal requested for access. The contents downloading may be executable with performing other processes. The HTML parsing, the Java script execution, the CSS execution and the screen arrangement and rendering may all be executed by a time sharing (time division) method, thereby reducing a time taken by loading a webpage.

As described above, the exemplary embodiments of this specification may provide a chain management system for providing a different screen for each of a plurality of terminals, which manage chain stores, based on device management screens and status data, and a user screen display method thereof. According to the system and method, search information on the device management screens may be stored and a user context may be created from the search information in advance, so as to receive only data related to the user context when the terminal re-accesses a central server, thereby reducing a generation and loading time of a screen of the terminal.

The exemplary embodiments may employ a central server, which generates control data based on status data and transmits device management data and the control data to a remote management server and a device, respectively, thereby allowing a manager of each chain store to manage and control devices within the corresponding chain store by remote control. Also, the provision of the remote management server, which is connected to the central server to provide the device management data for management of the device, may allow for management and control of devices within chain stores located at remote positions from the central server.

In addition, the exemplary embodiments may employ a central server which outputs error history data to a remote management server or report the same to a user or manager, so as to individually notify an occurrence of an erroneous state of devices within each chain store to a user or manager of the corresponding chain store, thereby efficiently managing the chain store. To this end, the central server may compare status data with a preset threshold value to generate and update error history data when the erroneous state is continued and output the error history data when a preset threshold time elapses, thereby preventing data overload toward a manager server or service center.

1. A chain management system comprising:
at least one device located within a chain store to transmit status data;
at least one terminal having a user screen to display device management data for the device; and
a central server to generate first data for management and control of the device based on the status data and the device management data and provide the first data to the device, the central server generating second data based on the status data and device management screens searched so as to configure a different user screen and providing the corresponding user screen to the terminal.

2. The system of claim 1, further comprising a gateway connected between the terminal and the central server to transmit and receive the first data and the second data.

3. The system of claim 1, further comprising a remote management server connected to the central server to provide the device management data for management of the device,
wherein the remote management server is a web server to generate the device management screen,
wherein the central server transmits screen control data for the device management screen and the first data to the web server and the device, respectively and generates the first data based on a control command input by the terminal, and generates the device management data or the screen control data based on a search command input by the terminal.

4.-7. (canceled)

8. The system of claim 2, further comprising a local controller to transmit the first data for remote control of the device from the central server to the device,
wherein the gateway is disposed between the local controller and the central server so as to convert the status data according to a remote communication protocol and transmit the converted data to the central server, the gateway transmitting the first data to the local controller.

9. (canceled)

10. The system of claim 3, wherein the central server further comprises an application server to generate the first data for remote control of the device according to the remote communication protocol,
wherein the application server generates the first data based on user information input is a window disposed on the device management screen Or by analyzing the status data stored in the storage unit.

11. (canceled)

12. The system of claim 1, wherein the status data is at least one of air conditioner information, refrigeration information, lighting information, power consumption information, device history information, facility error information and a power-consumed amount, each detected at a current access time,
wherein the device management screen is at least one of screens for at least one of air conditioner information refrigeration information, power consumption information, facility information, error history information, error setting information and detailed information on energy consumption.

13. (canceled)

14. The system of claim 3, wherein the screen control data comprises:
a header containing data of system information and version information relating to the device; and
a body containing an ID, a group number, an operational state, an operation mode, temperature and power consumption relating to the device.

15. The system of claim 1, further comprising a web server to generate a different user screen for each terminal based on the second data received from the central server.

16. The system of claim 1, wherein the central server arranges a user context, to which the device management screen is reflected, on the user screen, and generates the second data to display the status data on a data box of the user context.

17. The system of claim 16, wherein the user context is divided windows or lists, and
wherein an arrangement order of the divided windows or lists corresponds to a search rate or lately searched order for the device management screens performed by the terminal upon previous accesses thereof, or a size of the divided window is decided according to the search rate.

18. The system of claim 2, wherein the central server comprises:
an input unit to receive the status data from the device;
a control unit to arrange the device management screens on the user screen based on the device management screen and the status data input via the input unit, and generate the second data to display the status data on the device management screens; and
an output unit to output the second data to the web server.

19. The system of claim 18, wherein the control unit comprises:
a screen configuring portion to configure the user screen such that the device management screens are arranged on the user screen; and
a main controller to display the status data on the user screen and generate the second data for reconfiguring the user screen configured by the screen configuring portion.

20. The system of claim 1, wherein the first data is error history data of the device, and
wherein the central server comprises a database to store, in an accumulative manner, the status data, error setting data including preset threshold value and threshold time, and the error history data.

21. The system of claim 20, wherein a remote management server is provided, the remote management server being connected to the central server to provide device management data for management of the device, and
wherein the central server comprises a state control unit to detect whether an error is generated in the device from the status data, and output the error history data to the remote management server when the erroneous state is continued over the threshold time.

22. The system of claim 21, wherein the state control unit comprises:
a variable setting portion to set error setting data; and
a signal generating portion to initialize an operation time when the status data value is greater than a threshold value set by the variable setting portion, and generate and output a lapse signal when the operation time exceeds the threshold time.

23. The system of claim 22, wherein the state control unit further comprises a state managing portion to store the error history data generated during the operation time of the signal generating portion in the database in an accumulative manner, and output the error history data to the remote management server when the lapse signal is received from the signal generating portion.

24. The system of claim 22, wherein the state control unit further comprises a state checking portion to receive status data from each device determined to be erroneous and check whether the erroneous state is continued when the lapse signal is received from the signal generating portion,
wherein the state control unit further comprises a state determining portion to determine presence or non-presence of the error by analyzing the status data.

25. (canceled)

26. The system of claim 24, wherein the state control unit further comprises a message transmitting portion to convert error history data of a device, checked by the state checking portion as the erroneous state being continued, into a format of email or Short Messaging Service (SMS) so as to transmit to a user.

27. A user screen display method for a chain management system, the chain management system comprising at least one device located within each chain store to transmit status data thereof, at least one terminal having a user screen to display the status data of the device, and a central server connected to the terminal via a network, the method performed by a central server comprising:
storing search information relating to a device management screen searched by the terminal;
receiving the status data from the device;
generating control data for the terminal based on the device management screen and the status data; and
displaying a different user screen for each terminal according to the control data.

28. A remote management method for a chain management system, performed by a central server, the chain management system comprising at least one device located within each chain store to transmit status data thereof, at least one terminal having a user screen to display the status data of the device, and a central server connected to the terminal via a network, the method comprising:
receiving the status data;
generating error history data while an erroneous state that the status data is greater than a preset threshold value is continued; and
outputting the error history data to a remote management server or a user when the continued time of the erroneous state exceeds a preset threshold time.
